(19) United States
(12) Patent Application Publication
(10) Pub. No.: US 2017/0182829 A1
(43) Pub. Date: Jun. 29, 2017

(54) ELECTRON BEAM CURING OF POLYMERIC INKS

(71) Applicant: Energy Sciences Inc., Wilmington, MA (US)

(72) Inventors: Imtiaz Rangwalla, Andover, MA (US); Edward Maguire, N. Andover, MA (US)

(21) Appl. No.: 15/389,759

(22) Filed: Dec. 23, 2016

Related U.S. Application Data
(60) Provisional application No. 62/271,735, filed on Dec. 28, 2015.

(51) Int. Cl. B41M 7/00; C09D 11/101; C09D 11/108; B05D 3/06; B05D 7/26

(52) U.S. Cl. CPC B41M 7/0081; B05D 3/068; B05D 7/26; C09D 11/108; C09D 11/101

(57) ABSTRACT

Methods of electron beam (EB) curing of polymeric inks are provided. Surface printed substrates with polyolefinic inks (for example, HP indigo electro inks) are used with EB cured lacquers and/or instant cure EB laminating adhesives. EB treatment of polymeric inks can achieve cross-linking in at least one portion of the polymeric inks and can improve the temperature and pressure resistant properties of the polymeric inks.

### CROSS-REFERENCE TO RELATED APPLICATIONS

The present application claims the benefit of and priority from U.S. Provisional Patent Application No. 62/271,735, entitled “Electron Beam Curing of Polymeric Inks” filed Dec. 28, 2015, the entire disclosure of which is incorporated herein by reference.

### TECHNICAL FIELD

Embodiments of the disclosure relate generally to systems and methods of electron beam (EB) curing, and more particularly, electron beam curing of polymeric inks.

### BACKGROUND

Flexible packaging is widely used for food, non-food, and pharmaceutical applications. Flexible packaging uses a wide range of different types of materials including various types of plastic films, paper, and aluminum foil. The plastic films include various types of polyolefins, polyesters, and polyamides. The films may be various combinations of homopolymers, copolymers, and polymer blends. The films may be a single layer or may be coextruded in multiple layers. The films are also commonly coated, metalized, or otherwise treated to enhance the performance of the resulting package. Packaging materials and structures are selected based on a variety of factors including desired barrier properties, appearance, cost, physical feel, printability, sealing properties, easy open features, and reclosing features.

Printing is an important unit operation step for packaging applications. Films can be reverse printed and then laminated using conventional solvent or water based or solvent less laminating adhesive to a sealant film or in some cases to aluminum foil and then a sealant film making a tri-layer structure. These adhesives are time-cured adhesives requiring, in some cases, three to seven days to cure. In some cases, these films are surface printed using one layer or a pre-laminate comprising of two to three layers. These films can be printed by, for example, any one of these printing processes: 1) flexography in-line or Central Impression (CI); 2) roto gravure; 3) sheet or web offset; or 4) digital printing (for example HP Indigo offset printing).

There is a need for printing methods that can achieve (among other things) quicker turnaround, lower costs, lower volatile organic compound (VOC) emission, and lower carbon foot print.

### SUMMARY

The present disclosure relates to printed films and methods for printing, comprising for example, electron beam curing of polymeric inks. In one embodiment, the methods can comprise surface printing a substrate with a polymeric ink and curing the polymeric ink with an electron beam treatment. The polymeric ink can comprise a polyolefinic binder ink. The polymeric ink can comprise HP Indigo ink. In one embodiment, the electron beam treatment can achieve cross-linking of at least one portion of the polymeric ink. The electron beam treatment can comprise a dosage of 3 to 12 megarads. The electron beam treatment can comprise 60-125 kV and 40-120 kGy.

### DETAILED DESCRIPTION

The following detailed description is exemplary and explanatory and is intended to provide further explanation of the present disclosure described herein. Other advantages, and novel features will be readily apparent to those skilled in the art from the following detailed description of the present disclosure.

In some embodiments, polyolefinic binder inks are used, for example (without limitation) HP Indigo Electro inks. Polyolefinic inks can be efficient and cost effective for providing high digital quality printed image, quick turnaround and are suited for short runs and just-in-time (JIT) market needs. The polyolefinic binder inks can be charged and then deposited on a primed substrate with mineral oil as a carrier. Depending on the application, a clear substrate, for example (without limitation), oriented polypropylene (OPP), polyethylene terephthalate (PET), polyethylene (PE) etc., can be reverse printed with digital inks and then laminated using conventional polyurethane (PU) adhesive to other substrates. In some cases, the ink can surface printed and then a clear overprint varnish can be applied for aesthetic and protection reasons.

Several different types of adhesives or lacquers can be used. In some embodiments of the present disclosure, EB cured lacquers and instant cure EB laminating adhesives are used. In some embodiments, surface printed substrates with polyolefinic inks (for example, HP indigo electro inks) are used with EB cured lacquers and/or instant cure EB laminating adhesives. Surprisingly and unexpectedly, pouches made from surface printed EB lacquers exhibited much better print dot integrity at heat seal areas when compared to pouches made from surface printed with HP indigo inks and coated with conventional solvent based lacquers or ultraviolet (UV) cured lacquers and also when compared to laminates in which conventional non-EB cured adhesives were used.

By using EB lacquer, the lacquer is not only cured but also crosslinking of the polyolefinic based ink is achieved. By crosslinking the polyolefinic ink, the molecular weight of the ink is increased, and the ink is made more temperature resistant, abrasion and solvent resistant, and tougher. Thus, the ink is able to better withstand high temperature and pressure heat seal processes required during pouch making. In some applications where the heat seal process is not very severe (for example, seal temperatures of 120-200° C.), no lacquer may be used and just surface printed inks are EB cured at a dose of 40-120 kGy, and preferably 60-80 kGy, and 60-125 kV of operating voltage. In these applications, the EB cured surface ink exhibited acceptable solvent and temperature resistance. The temperature resistance is required for the surface printed ink to withstand further operation steps like heat sealing which is involved in making pouches. These advantages could not be achieved without EB curing the digital inks. For applications where a laminate is required, EB adhesives can be used. Curing the EB adhesive can achieve curing and crosslinking of the ink and achieve similar advantages. The EB treatment can be at a dosage of 3-12 megarads, and preferably 6-9 megarads.

In some embodiments, a surface print clear substrate with polymeric inks (for example HP indigo inks) is EB treated. The EB treatment is at 60-125 kV and 40-120 kGy.

In other embodiments, a surface print, pre-laminated, mono film, and aluminum foil with polymeric inks (for example HP indigo inks) and EB lacquer is EB treated. The EB lacquer is at 2-4 gsm. The EB treatment of the ink and lacquer is at 60-125 kV and 40-120 kGy.

In other embodiments, a reverse clear substrate with polymeric inks (for example HP indigo inks) and a clear laminate added to white aluminum foil with EB laminating adhesive is EB treated. The EB treatment is at 60-125 kV and 40 -120 kGy.

### EXAMPLE 1

Example 1 demonstrates the effect of electron beam (EB) curing on polymeric ink alone. The polymeric ink is a polyolefinic based ink from Hewlett Packard (HP). The substrate used is: HP ink/C1S paper/adhesive/metallized polyethylene terephthalate (PET)/adhesive/low-density polyethylene (LDPE). The heat seal condition is as follows: heat to top bar; pressure: 1 Bar; dwell time: 1 second. Table 1 below shows the results of Example 1.

TABLE 1

| Electron beam | | Heat seal | |
|---|---|---|---|
| (EB) treatment | Dose | temperature | |
| (kV) | (mrad) | (° C.) | Observations |
| 125 | 0 | 140 | Discoloration and cracking of |
| | | | ink |
| 125 | 6 | 140 | Ok |
| 125 | 6 | 160 | Slight discoloration and ink |
| | | | cracking |
| 125 | 12 | 160 | Ok |
| 125 | 12 | 180 | Ok |
| 125 | 12 | 200 | Discoloration and cracking of |
| | | | ink |

### EXAMPLE 2

Example 2 demonstrates the effect of electron beam (EB) curing of lacquer on polymeric ink. The lacquer is EB lacquer from Greenpack LLC. The polymeric ink is a polyolefinic based ink from Hewlett Packard (HP). The substrate used is: EB lacquer/HP inks/aluminum foil/heat seal lacquer. This type of substrate can be used for yogurt lids, for example. The heat seal condition is the same as in Example 1: heat to top bar; pressure: 1 Bar; dwell time: 1 second. The EB lacquer is applied at 4 grams/m² by offset gravure or flexography method with inline corona treatment so that the dyne level is 42 dynes/cm. Table 2 below shows the results of Example 2.

TABLE 2

| Electron beam | | | |
|---|---|---|---|
| (EB) treatment | | Heat seal temperature | |
| (kV) | Dose (mrad) | (° C.) | Observations |
| 125 | 6 | 220 | Ok |
| 125 | 6 | 240 | Ok |

Conventional inks used in the industry, for example nitrocellulose based inks, that are used with conventional solvent based printing do not show improvement after undergoing EB treatment. The results of Examples 1 and 2 unexpectedly demonstrate the improvement of using EB treatment to cure polymeric inks. One skilled in the art would not expect such an improvement because EB curing on conventional inks do not show improvement. The inventors have unexpectedly discovered that EB curing of certain polymeric inks, for example polyolefinic inks, result in improvements to the inks. The improvements include (without limitation) lessened or no discoloration and ink cracking, temperature resistance, and other enhanced properties. The unexpected improvements are a result of the EB treatment crosslinking the polyolefinic ink.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

1. A method for printing comprising:
surface printing a substrate with a polymeric ink; and
curing the polymeric ink with an electron beam treatment.

2. The method of claim 1, wherein the polymeric ink comprises a polyolefinic binder ink.

3. The method of claim 1, wherein the polymeric ink comprises HP Indigo Electro Ink.

4. The method of claim 1, wherein the electron beam treatment achieves cross-linking of at least one portion of the polymeric ink.

5. The method of claim 1, wherein the electron beam treatment comprises a dosage of 3 to 12 megarads.

6. The method of claim 1, wherein the electron beam treatment comprises 60-125 kV and 40-120 kGy.

7. The method of claim 1, wherein the substrate comprises a surface print clear substrate.

8. The method of claim 1, wherein the substrate comprises a surface print, pre-laminated, mono film, aluminum foil, and electron beam lacquer.

9. A printed film comprising:
a substrate, and
a polymeric ink printed on the substrate,
wherein the polymeric ink is electron beam treated.

10. The printed film of claim 9, wherein the polymeric ink comprises cross-linking in at least one portion of the polymeric ink.
